(19) United States
(12) Patent Application Publication
(10) Pub. No.: US 2009/0157905 A1
(43) Pub. Date: Jun. 18, 2009

(54) System and Method for Standardizing Clocks in a Heterogeneous Networked Environment

(75) Inventor: Bradford C. Davis, Erie, CO (US)

Correspondence Address: BAKER BOTTS L.L.P., 2001 ROSS AVENUE, SUITE 600, DALLAS, TX, 75201-2980, US

(73) Assignee: Computer Associates Think, Inc., Islandia, NY (US)

(21) Appl. No.: 12/248,742

(22) Filed: Oct. 9, 2008

Related U.S. Application Data
(63) Continuation of application No. 10/890,314, filed on Jul. 12, 2004, now abandoned.
(60) Provisional application No. 60/486,596, filed on Jul. 11, 2003.

(51) Int. Cl. G06F 15/16

(52) U.S. Cl. 709/248

(57) ABSTRACT

A system and method for standardizing clocks in the heterogeneous networked environment is provided. In one aspect the duration of time that a message takes to travel from a source machine to a destination machine is decomposed into actual duration time T for transmission,—and time difference. C between the source machine and the destination machine. Two T's for each leg of a round trip transmission is determined and t˜ using the two T's is estimated. A measure of each leg of round trip transmission is determined using t˜ and C. An offset for a machine within a known delta is established.

### CROSS-REFERENCE TO RELATED APPLICATIONS

This application is a continuation of U.S. patent application U.S. Ser. No. 10/890,314 filed Aug. 25, 2005, which claims the benefit U.S. Provisional Patent Application No. 60/486,596 entitled SYSTEM AND METHOD FOR STANDARDIZING CLOCKS IN A HETEROGENEOUS NETWORKED ENVIRONMENT filed on Jul. 11, 2003, the entire disclosure of which is incorporated herein by reference.

### TECHNICAL FIELD

This application relates generally to computer systems, and more particularly to standardizing clocks in computer processors in the heterogeneous networked environment.

### BACKGROUND

Machines such as computers and computer processors typically include a clock. However, the clocks in different machines, including those machines that are in the same time zone and where some form of time normalization software has been deployed, frequently differ by a number of seconds. Clock differences also accrue as a result of time-zone differences that further complicate the normalization effort.

### SUMMARY

Standardizing clocks in the heterogeneous networked environment is provided. In one aspect the duration of time that a message takes to travel from a source machine to a destination machine is decomposed into actual duration time T for transmission, and time difference C between the source machine and the destination machine. Two T's for each leg of a round trip transmission is determined and t˜ using the two T's is estimated. A measure of each leg of round trip transmission is determined using t˜ and C. An offset for a machine within a known delta is established.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a block diagram illustrating the components of the present disclosure in one embodiment.

FIG. 2 is a diagram that illustrates the data structure of a normalization offset used-in one embodiment of the present disclosure.

FIG. 3 is a flow diagram illustrating the method of the present disclosure in one embodiment.

### DETAILED DESCRIPTION

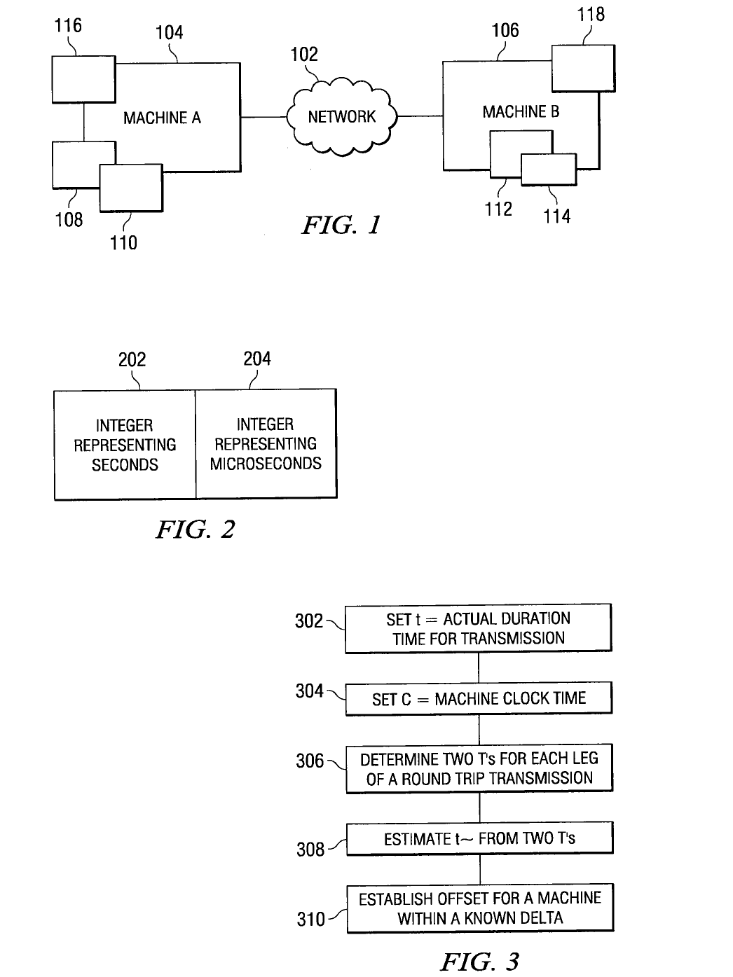

FIG. 1 is a block diagram illustrating the components of the present disclosure in one embodiment. Machines A and B 102, 104 may be any device or machine already known or will be known in the future that keeps time, for example, with one or more clocks on the device. Such machines may include but are not limited to computers of any size, laptops, personal computers, PDA's (personal data assistants), cellular phones. Machines A and B 102, 104 may include processors 108, 112, and memory units 110, 114. Machines A and B 102, 104 also may include communication capability through a network 102 for communicating to each other and to other machines. The network 102 may include, but not limited to, any known or will be known communication media such as the Internet, WAN (wide are network), LAN (local area network), cellular network, satellite network, or even a direct connection. The synchronization components 116, 118 of the present disclosure may reside in the respective machines A 104 and B 106.

FIG. 2 is a diagram that illustrates the data structure of a normalization offset used in one embodiment of the present disclosure. In one embodiment, a normalization offset includes two components: integers representing seconds 202 and microseconds 204. The two components 202, 204 are written to a pair of environment variables, which are available to any process on that machine. By adding that offset to the system time, any process can synchronize itself with a leader process anywhere in the network, without interfering with a single system clock.

The synchronization method and system of the present disclosure may be run periodically, for instance, for a few seconds once an hour and keep the entire enterprise synchronized.

FIG. 3 is a flow diagram illustrating the method of the present disclosure in one embodiment. Let Δ be a quantity of time with one component in seconds and another component in microseconds known as the time it takes a message to make it from one machine to another. This value is generally unknown to any degree of precision. For example, by getting on the phone and by watching the log of a particular processes, the sending of messages can be controlled and this value can be bound using verbal communication and visual reading of log files which show message receipts. According to one embodiment of the present disclosure, this value is computed within allowable tolerances using, for example, a convergence algorithm described herein.

Δ is decomposed into two components, neither of which are known. At 302, the first component, t, is the actual duration time for the transmission where that time begins with the execution of the send function and ends with the execution of the receive function. The second component, C, is clock time measured in seconds since 1970 with a second integer component in microseconds at 304. Clocks will generally differ by some unknown quantity and the exemplary embodiments quantify this unknown to the best degree possible, normalized for differences in time zone and daylight savings time, which may simultaneously be in effect and not be in effect on machines in different time zones.

So unknown Δ is expressed by two unknowns, t, the actual time it takes for the message to travel and C=C_{local}−Cᵣₑₘₒₜₑ, which also is unknown and which is sought to be defined. C is unknown in that the clocks on both machines cannot be seen simultaneously. If both clocks could be seen, then C would be known and the machine's clocks would be set accordingly.

For example, at 306 two T's are calculated from a message making a roundtrip on the same socket with the minimal turnaround time possible on the remote machine, so that the second message may find, the network in the same condition as it was for the first message.

These T's are expressed as:

T₀=t₀+C_{local}−Cᵣₑₘₒₜₑ

T=t₁+C_{local}−Cᵣₑₘₒₜₑ.

In one embodiment, the actual transmission time |t₀| and |t₁| are assumed to be close since they are derived from like messages sent on the same socket within close proximity of one another. From t₀ and t₁, an estimator t˜ to approximate t₀ and t₁ are defined.

The two T's are expressed where Cᵣₑₘₒₜₑ is an unknown C˜, and it is calculated as a function of the estimator t˜. First, however, t˜ is estimated in terms of available values at 308. A second pair of definitions is considered where T is a difference as measured in POSIX seconds (seconds as an integer since the first second of 1970) and the microseconds from that second. So that in the definition of these T's, each component of the roundtrip is

T₀=|C_{remote receive}−C_{local send}|

T₁=|C_{local receive}−C_{remote send}|

These theoretical times are unknown, but the definitions in terms of the respective clocks realizing the precise times of the respective sends and receives is reasonable. Note the absolute value operator so that these differences are always positive.

Δ_{clock} is the actual offset measured in the same units of time but is the unknown thereafter. It is considered constant across any short duration of time, assuming that whatever clock drift may exist in a particular clock does not manifest within the space of a given roundtrip.

Δclock=C_{local}−Cᵣₑₘₒₜₑ

Now T₀ and T₁ are expressed as:

T₀=t˜+Δ_{clock}

T₁=t˜−Δ_{clock}

Or a measure of the respective legs of the roundtrip in a mean estimated transmission time and some unknown difference in clocks whose relative difference is constant over the interval of the roundtrip.

Applying the absolute value operator and summing

|T₀=|t˜|+|Δ_{clock}|

|T₁=|t˜|+|Δ_{clock}|

yields

(Tₒ+T₁)/2=(t˜+Δ_{clock})

t˜=((T₀+T₁)/2)−Δ_{clock}

Δ=((T₀+T₁)/2)
being a quantity computed as the roundtrip time measured from the local node or the node that initiated the transmission, and the estimator

t˜=Δ−Δ_{clock}

Two unknowns still exist but an iterative algorithm can be devised that will quickly converge to the actual offset in seconds and microseconds of the remote node.

A single roundtrip is completed and Δ is computed measuring from the local node. t˜ is initialized to zero and C is estimated,

C_{remote est}=C_{local}+t˜+Δ_{clock}

and

C_{remote est}=C_{local}+t˜−Δ_{clock}

Let t˜=0 for the first estimation of C_{remote est} be either

C_{remote est}=C local+A

or

C_{remote est}=C_{local}−A

C_{remote est} is assumed to have an error, namely the mean transmission time for the round trip. This provides two candidates for the next approximation for C_{remote est}.

t˜=C_{remote est}−C_{remote actual}

or

t˜=C_{remote actual}−C_{remote est}

In one embodiment, the transmission time is greater than zero. Therefore, if the estimation of t˜ is negative, a suggestion exist as to what the proper order of the subtraction should be. Add or′ subtract |t˜| from C_{remote est}, reset t˜ to zero, and recompute. In one embodiment, C_{remote est} is computed on the local node and not reset on the remote node. Its value is used on the local node and continually revised on the local node until convergence, or termination of the algorithm, at which point the offset for that remote has been established to within a known delta.

Convergence is achieved when for some δ there is

|t˜|<=δ; or, some number of iterations has been exceeded. A desirable number of iterations is deemed exceeded if consecutive oscillations between positive and negative t˜ occur. This suggests that the network condition precludes the assumption of a uniform roundtrip. This |t˜| is the delta of precision for which the respective clocks can be synchronized.

The achievable delta and the necessary time and CPU to achieve this delta, suggests one measure of performance between competing messaging software.

The method and system in one embodiments can be designed to run in a thread within a bridge (ccirmtd, DIA, etc.) or as a standalone process on every node in a given enterprise where clock synchronization is-deemed desirable.

The system and method of the present disclosure may be implemented and run on a general-purpose computer. For example, the system and method may be implemented as set of computer instructions to be stored on computer memory units and executed on the computer processor. The embodiments described above are illustrative examples and it should not be construed that the present invention is limited to these particular embodiments. Thus, various changes and modifications may be effected by one skilled in the art without departing from the spirit or scope of the invention as defined in the appended claims.

I claim:

1. A method for standardizing clocks in the heterogeneous networked environment, comprising:
decomposing the duration of time that a message takes to travel from a source machine to a destination machine into actual duration time T for transmission, and time difference C between the source machine and the destination machine;
determining two T's for each leg of a round trip transmission;
estimating t˜ using the two T's;
determining a measure of each leg of round trip transmission using t˜ and C; and
establishing an offset for a machine within a known delta.

2. The method of claim 1, wherein the establishing further includes:
converging the C value until a known delta is established.

3. The method of claim 1, wherein clock time of the destination machine used to determine the C is estimated.

4. The method of claim 1, wherein clock time of the source machine used to determine the C is actual.
